(19) United States
(12) Patent Application Publication
(10) Pub. No.: US 2016/0334809 A1
(43) Pub. Date: Nov. 17, 2016

(54) WATER PRESSURE REDUCER

(71) Applicant: Itron France, Issy-les-Moulinaux (FR)

(72) Inventors: Anthony Laurens, Issy-les-Moulinaux (FR); Maxime Aujas, Issy-les-Moulinaux (FR); Christophe Depeyre, Issy-les-Moulinaux (FR)

(73) Assignee: Itron France

(21) Appl. No.: 14/711,682

(22) Filed: May 13, 2015

(51) Int. Cl. G05D 16/16

(52) U.S. Cl. CPC G05D 16/166

(57) ABSTRACT

A water pressure reducer using compression forces with an inverse upstream to downstream pressure relationship, and a method of operating the same, is disclosed. The water pressure reducer may include a housing defining first and second chambers separated by a membrane. Water pressure within the second chamber biases the membrane in a first direction opposite the force of a spring within the first chamber, decreasing flow through a valve seat and into downstream water lines. Decreased water pressure within the second chamber biases the membrane in a second direction, increasing flow through the valve seat and water flow to downstream pipes. Biasing of the membrane in the first direction and the second direction can occur continuously as water pressure from the upstream water line increases and decreases.

### BACKGROUND

Many residential and commercial buildings receive water from city, county, municipality, or other incoming water pipes, also known as water lines. The water pressure in these water lines can be substantial when that pressure is uncontrolled or when the water lines are designed to provide water to many residential and commercial buildings at the same time. Additionally, water pressure from incoming water lines may “spike” or increase sharply at a given time depending on end user consumption and water input. However, most residential and commercial buildings do not require the magnitude of water pressure that is provided in incoming water lines, and in fact, such high water pressure may harm some residential and commercial piping or the appliances such as washers, refrigerators, and shower heads in those buildings.

To prevent residential and commercial piping and appliances from damage caused by high water pressure or water pressure spikes, pressure reducers have been employed. Water pressure reduction technology has consisted of either a piston-type system or a membrane-type system, both of which rely on tension or traction forces to operate, causing stress on various components of the systems and leading to decreased service life. Also, in both the piston-type and membrane-type applications, a proportional relationship exists between upstream water pressure and downstream water pressure such that as upstream water pressure increases, downstream water pressure also increases. Thus, at high enough upstream water pressures, the downstream water pressure, while less than the upstream pressure, may still damage downstream pipes and appliances.

### BRIEF DESCRIPTION OF THE DRAWINGS

The detailed description is set forth with reference to the accompanying figures. In the figures, the left-most digit(s) of a reference number identifies the figure in which the reference number first appears. The use of the same reference numbers in different figures indicates similar or identical items.

FIG. 1 illustrates a perspective view of a water pressure reducer as installed in a water line system in a residential application with various appliances;

FIG. 2 illustrates a side, cross-sectional view of a water pressure reducer with right-to-left water flow and pipe connections;

FIG. 3 illustrates a side, cross-sectional view of a water pressure reducer with a left-to-right water flow and when low upstream pressure is applied;

FIG. 4 illustrates a side, cross-sectional view of a water pressure reducer with a left-to-right water flow and when high upstream pressure is applied; and

FIG. 5 is an exemplary flowchart illustrating an example by which a water pressure reducer may operate.

### DETAILED DESCRIPTION

### Overview

This disclosure describes example water pressure reducers that rely on compression forces, instead of tension or traction forces, to operate. This disclosure also describes example water pressure reducers wherein an inverse relationship exists between upstream and downstream water pressure such that an increase in upstream water pressure results in a decrease in downstream water pressure. Additionally, the disclosure describes a method of operating water pressure reducers such as those described herein.

In one example, a pressure reducer may be configured as a two-chamber design. A housing may define a first chamber releaseably coupled to a second chamber and a membrane situated between the first and second chambers. The first and second chambers may also be defined by a cover and a base, respectively. A spring in the first chamber can apply force to the membrane, biasing or flexing the membrane at least partially into the second chamber. A plunger can be included in the second chamber and can be coupled to the membrane such that when the spring in the first chamber compresses and decompresses, the plunger moves within the second chamber in first and second directions, respectively. When the plunger moves in the first direction responsive to higher water pressure, a driver coupled to the plunger can be biased toward a valve seat within the second chamber, restricting or prohibiting water flow to downstream pipes and appliances. When the plunger moves in the second direction responsive to lower water pressure, the driver can be biased away from the valve seat, promoting increased water flow to downstream pipes and appliances. The membrane can have a flexing range that can allow for continuous expansion and contraction of the spring, and thus smooth and continuous movement of the plunger and driver in the first and second directions.

In another example, a water pressure reducer may be configured to include an inlet opening in the base. The base can also define an inlet port near the inlet opening that can be coupled to the valve seat. The valve seat can further define an outlet port through which the plunger can extend. In this example, the upstream water pressure can apply compression force to the membrane, and does not apply tension or traction forces to any other components of the pressure reducer.

In another example, a method of operating a water pressure reducer such as that described herein can include receiving liquid within the base portion of the housing, wherein the liquid has an inlet pressure. Then, the membrane may move responsive to a balance between an upward force by the water pressure within the base portion and a downward force by the spring in the cover. If the water pressure is greater than the spring's force, the spring will compress and bias the membrane, the plunger, and the driver in the first direction to thereby decrease the distance between the driver and the valve seat. Disposition of the membrane in the first direction can cause an outlet pressure that is less than the inlet pressure. If the water pressure is less than the spring's force, the spring can extend and bias the membrane, the plunger, and the driver in the second direction that increases the distance between the driver and the valve seat. Disposition of the membrane in the second direction can cause an outlet pressure that is lower than or equal to the inlet pressure.

Water pressure reducers according to this disclosure may be designed for use with a variety of water lines, such as, for example, potable water and sewage lines in residential or commercial applications.

The present disclosure will now be described to provide an overall understanding of the principles of the structure, function, manufacture, and use of the devices and methods disclosed herein. One or more examples of the present disclosure are illustrated in the accompanying drawings. Those of ordinary skill in the art will understand that the devices and methods specifically described herein and illustrated in the accompanying drawings are non-limiting embodiments and that the scope of these embodiments is defined solely by the claims. The features illustrated or described in connection with one embodiment may be combined with the features of other embodiments. Such modifications and variations are intended to be included within the scope of the appended claims.

Additional details are described below with reference to several example embodiments.

### Example Water Pressure Reducer

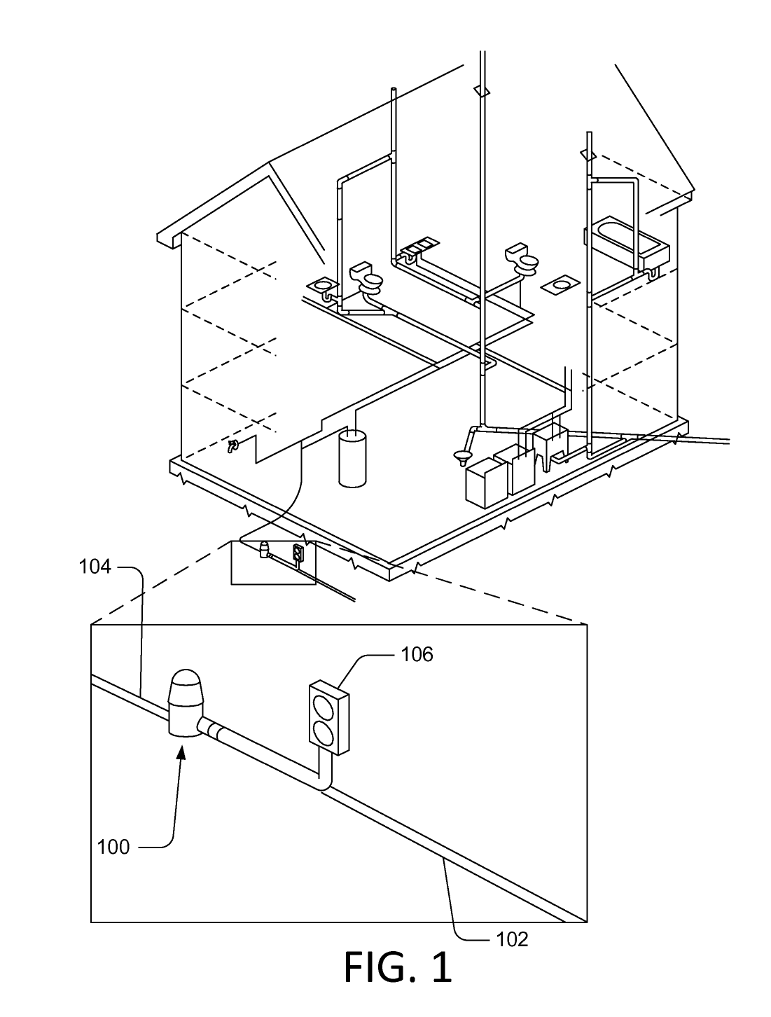

FIG. 1 illustrates an example of a water pressure reducer 100 as installed in a water line. The water pressure reducer 100 can be installed at any point between the upstream water line 102, serving a plurality of customers, and the downstream water line 104, serving a single customer. In the example of FIG. 1, the water pressure reducer 100 is installed in the water line after the water usage meter 106 for the building that the upstream water line 102 is serving. The water pressure reducer 100 can reduce water pressure in the downstream water line 104 such that appliances hooked up to the downstream water line 104 receive water pressure below a threshold pressure to prevent damage to those appliances. An appliance, as described herein, can be any water outlet in the downstream water line 104, such as bathtubs, toilets, sinks, refrigerators, washers, hot water heaters, etc.

In some embodiments, multiple water pressure reducers 100 can be installed in the same water line and in the same downstream water system. For example, one water pressure reducer 100 can be installed between the upstream water line 102 serving multiple customers and the downstream water line 104 serving a single customer or located at a customer's site. A second water pressure reducer 100 can be installed within the downstream water line 104 between the downstream piping and an appliance, for example. Use of multiple water pressure reducers 100 allows differing levels of protection to be given to various appliances within a water system. The water pressure reducers 100 disclosed herein can also be detached or otherwise removed from a water line and inserted into a new or different water line. As such, a water pressure reducer 100 can be used in one or in multiple water lines.

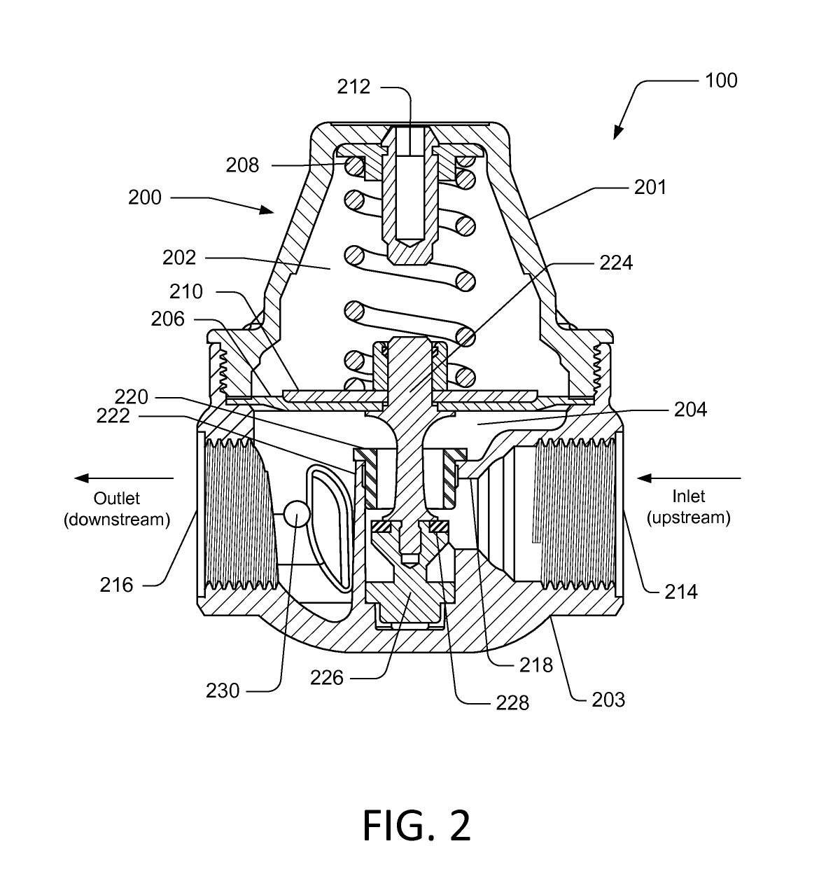

FIGS. 2-4 illustrate an example embodiment of a water pressure reducer 100. As shown in FIG. 2, the water pressure reducer 100 can include a housing 200 defining an at least partially hollow interior defining a first chamber 202 and a second chamber 204. The housing 200 may include a cover 201, which may define the first chamber 202, and a base 203, which may define the second chamber 204. In the example shown, the cover 201 and base 203 may be connected by a threaded connection, although others means of connection may be used, such as alternative fasteners, welding, or a unified construction. The cover 201 defining the first chamber 202 and the base 203 defining the second chamber 204 can be releaseably coupled together. A membrane 206 may be situated between the cover 201 and the base 203. The first chamber 202 defined by the cover 201 can include a spring 208. In one embodiment, the spring 208 can be in contact with the membrane 206 and the interior of the first chamber 202 defined by the cover 201. The spring 208 may bias the membrane 206 toward, or somewhat into, the second chamber 204 defined by the base 203. In another embodiment, the membrane 206 may have a footing 210 situated between the membrane 206 and the spring 208. In another embodiment, the cover 201 may also include a pressure adjustment component 212 situated at least partially between the interior of the first chamber 202 and the spring 208. The pressure adjustment component 212 may control a degree to which the spring is compressed or relaxed, to thereby provide control over a pressure of water discharged from the water pressure reducer 100. Accordingly, with regulation provided by the pressure adjustment component 212, the spring 208 can be configured to exert an adjustable force on the membrane 206 in the direction of the second chamber 204.

Still referring to FIG. 2, the base 203 may define an inlet opening 214 and an outlet opening 216. The inlet opening 214 and outlet opening 216 can be configured to be on opposite sides of the base 203, as shown in FIG. 2, or the inlet opening 214 and the outlet opening 216 can be configured at any point around the base 203. The inlet opening 214 can include an inlet port 218 situated within the second chamber 204 defined by the base 203. In one embodiment, the inlet port 218 can be situated at the junction where an upstream water pipe and the base 203 meet when the upstream water pipe and the base 203 are coupled.

The inlet port 218 can be substantially circular and can have the same diameter as the upstream water pipe or a smaller or larger diameter. In another embodiment, the inlet port 218 can have a diameter smaller than the diameter of the upstream water pipe to allow initial water pressure reduction before liquid reaches the membrane 206. A valve seat 220 can be at least partially coupled to the inlet port 218. In the example shown, the valve seat 220 is situated substantially perpendicular to the inlet port 218 such that only a portion of the valve seat 220 is coupled to the inlet port 218.

Still referring to FIG. 2, the valve seat 220 can be substantially circular and can have the same or differing diameters from the inlet port 218 and the upstream water pipe. The valve seat 220 can also extend at least partially into the inlet port 218 in some embodiments. The valve seat 220 can be at least partially coupled to an outlet port 222. The outlet port 222 can be substantially circular and can have a diameter that will allow the valve seat 220 to be received within the outlet port 222. As depicted in FIG. 2, the inlet port 218 and the outlet port 222 can be adjacent to each other or can share a side wall, and both the inlet port 218 and the outlet port 222 can be coupled to the valve seat 220. In some embodiments, the outlet opening 216 can be separate from the outlet port 222, and can be situated away from the valve seat 220 and the inlet port 218.

Still referring to FIG. 2, a plunger 224 can be releaseably coupled to the membrane 206 and extend through the outlet port 222 and the valve seat 220. When the inlet port 218, valve seat 220, and outlet port 222 are configured as shown in FIG. 2, a shaft is formed through which the plunger 224 can pass through. In some embodiments, the plunger 224 can extend through the membrane 206 and at least partially into the first chamber 202 and be coupled to the footing 210. In other embodiments, not shown, the plunger 224 may not extend into the first chamber 202. The plunger 224 may be releaseably coupled to the membrane 206 or the footing 210 through a variety of means, including but not limited to adhesive, rivets, male and female threads or joints, or “click-in” tongue and groves.

A driver 226 may be releaseably coupled to the plunger 224 and be positioned substantially opposite the membrane 206. The driver 226 can have a substantially flat upper portion and can be configured to engage the valve seat 220 such that, when engaged, the driver 226 comes into contact with the bottom portion of the valve seat 220 and creates at least a partial seal, hindering water flow through the valve seat 220. The driver 226, as described herein, may not independently bias the membrane 206 or the plunger 224. In some embodiments, the driver 226 can be a portion of the plunger 224 and be defined as the portion of the plunger 224 that has a larger radius than the portion of the plunger 224 that extends through the valve seat 220.

Still referring to FIG. 2, the driver 226 may include a gasket 228 on the upper portion configured to contact the valve seat 220 when the valve seat 220 and the driver 226 are engaged. The gasket 228 can promote the releaseable sealing of the driver 226 to the valve seat 220 and prevent or inhibit water flow from the inlet opening 214. The driver 226 can also be configured to include at least partially beveled sides. The partial beveling can allow water from the inlet opening 214 to surround the driver 226 and exert pressure toward the plunger 224. This force around the driver 226 can assist in flexing or biasing the membrane 206 to increase or decrease water flow to the outlet opening 216. As the driver 226 moves with the plunger 224 to compress the spring 208 responsive to increased upstream water pressure, a space under the driver 226 may be created (as shown in FIG. 4). This space can fill with water from the inlet opening 214, allowing additional water pressure to act against the spring 208.

The second chamber 204 may also include an air valve drain plug 230, which can be configured to allow air within the second chamber 204 to be drained from the second chamber 204. In one embodiment, the air valve drain plug 230 can be used after installation of the water pressure reducer 100 and if air builds up in the water pressure reducer 100 over time.

Still referring to FIG. 2, after the water pressure reducer 100 is installed in the water line, the pressure adjustment component 212 can be manipulated to increase or reduce the compression of the spring 208. For example, the pressure adjustment component 212 can be pressed or screwed further into the first chamber 202, which can cause the spring 208 to compress. This compression can cause additional force to be applied to the membrane 206, which in turn can require greater water pressure from the upstream water line to counteract the spring's 208 force and cause the plunger 224 and driver 226 to move. Likewise, pulling or unscrewing the pressure adjustment component 212 further out of the first chamber 202 can allow the spring 208 to expand, putting less pressure on the membrane 206 and requiring less water pressure from the upstream water line to counteract the spring's 208 force. Accordingly, by decompressing the spring with the pressure adjustment component 212, the water pressure reducer is responsive to lesser water pressures, and by compressing the spring, the water pressure reducer is responsive to greater water pressures.

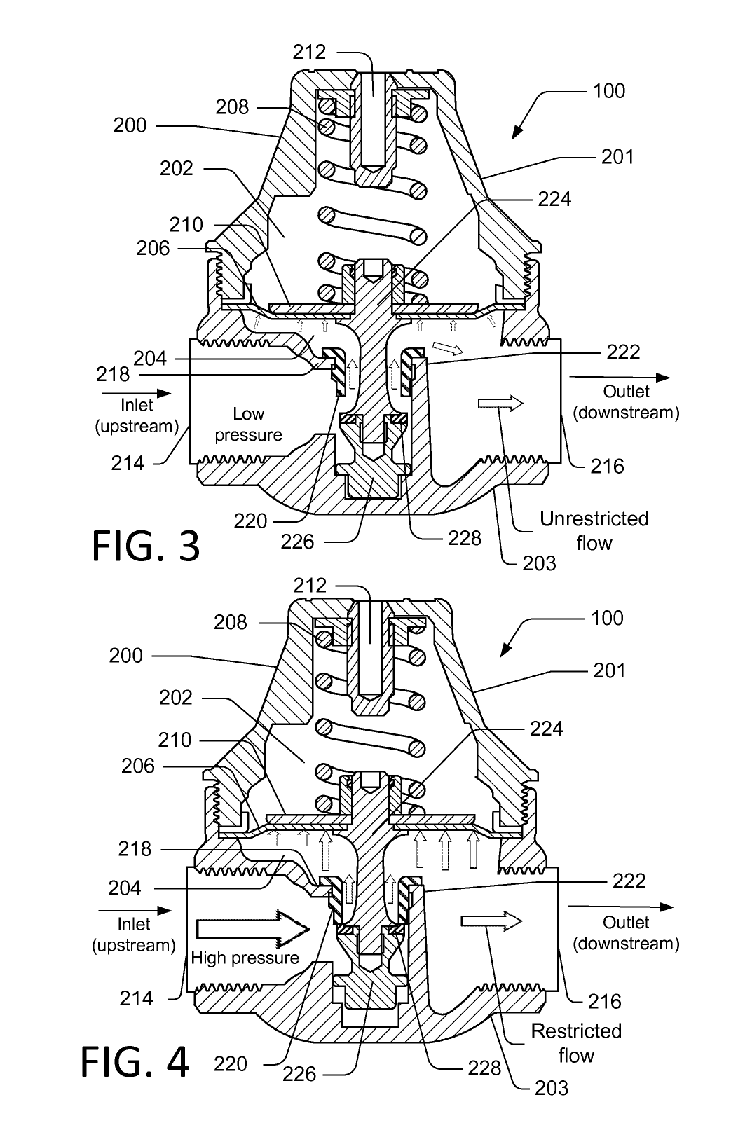

FIG. 3 shows an example operation of the water pressure reducer 100, wherein incoming water pressure is less than typical. In this condition, water can flow from the inlet opening 214, past the inlet port 218, valve seat 220, and outlet port 222, and out of the outlet opening 216. When water pressure from the upstream water line is low, the force of the spring 208 can flex or bias the membrane 206 downward and into the second chamber 204. In this low water pressure example, the driver 226 is not in contact with the valve seat 220, allowing water to flow from the inlet opening 214, through the valve seat 220 and outlet port 222, and out the outlet opening 216.

FIG. 4 shows an example operation of the water pressure reducer 100, wherein incoming water pressure is greater. In this condition, water pressure from the upstream water line compresses the spring 208. The water pressure within the second chamber 204 defined by the base 203 flexes or biases the membrane 206 toward the first chamber 202 defined by the cover 201, thereby drawing the plunger 224 and driver 226 upwards. When the force of water pressure within the second chamber 204 is greater than the force of the spring 208, the plunger 224 and driver 226 can be said to move in a first direction (i.e., upwardly, as shown). This upward motion moves the driver 226 toward the valve seat 220, thereby restricting water flow through the pressure reducer 100. If the pressure of the incoming water is great enough, the driver 226 will seat against the valve seat 220, effectively stopping water flow and protecting fixtures and appliances associated with the downstream piping from over-pressure damage. Thus, when incoming water pressure is sufficiently high, the plunger 224 and driver 226 can be biased in the first direction such that the driver 226 can move toward and may engage the valve seat 220, as shown in FIG. 4. When the driver 226 engages the valve seat 220, or when the driver 226 moves in the first direction, water pressure within the second chamber 204 can be reduced as water is output through the outlet opening 216 defined in the base 203. When the incoming pressure reduces, the force on the membrane 206 will be less, and the spring 208 will move the plunger 224 in a second direction (e.g., downwardly, as shown) thereby increasing water flow through the valve seat 220.

While FIGS. 3 and 4 show the plunger 224 and driver 226 in a fully open and fully closed position, respectively, the membrane 206 can force the plunger 224 and driver 226 into any position between fully open and fully closed. In one embodiment, when the membrane 206 is being biased in the first direction, the membrane 206 is biasing the driver 226 toward the fully closed position. When the membrane 206 is being biased in the second direction, the membrane 206 is biasing the driver 226 toward the fully open position. The position of the plunger 224 and driver 226, and direction of their movement, can be dependent on how much force is being applied to the membrane 206 by water pressure within the second chamber 204 relative to the force being applied by the spring 208. As such, the distance between the driver 226 and the valve seat 220 can smoothly and continuously change as water pressure within the second chamber 204 changes.

The components described above in the present disclosure and as shown in FIGS. 1-4 can be separate components coupled together, or can be produced as one component or as combined components. For example, the base 203 of the housing 200 defining the second chamber 204, inlet opening 214, outlet opening 216, inlet port 218, valve seat 220, and outlet port 222 can be one component. The cover 201 can also be one component. Also by way of example, the housing 200 can be one component defining the first chamber 202 and the second chamber 204. When the various components described in the present disclosure are separate components, some or all of the components can be releaseably coupled to the other components.

The water pressure reducers 100 described herein can be of varying sizes and scales. For example, a water pressure reducer 100 designed for residential application may be of a smaller size and scale than a water pressure reducer 100 designed for commercial applications.

The presently disclosed water pressure reducers 100 can be made of one or more of various materials, including but not limited to metal and plastic. When made of metal, the water pressure reducers 100 can be made of any metal with suitable strength and malleability, such as brass or bronze, to create the devices described herein. The various components of the water pressure reducers 100 disclosed herein may have additional grooves, slots, indentations, and other components to facilitate the function of the device as described herein.

The various components of the water pressure reducers 100 disclosed herein can be made using techniques known to those having skill in the art of metal working, including, for example, by milling or hot pressing. The membrane 206 can be made of a polymer having a crystallinity low enough to allow the membrane 206 to flex between the first chamber 202 and the second chamber 204. The polymer making up the membrane 206 can also have a tensile strength at least sufficient to withstand the force of compression from the spring 208 and the force of water pressure within the second chamber 204. Once the various components of the water pressure reducer 100 are made, the plunger 224 can be coupled to the membrane 206 as described above. The plunger 224, including the driver 226, can be situated through the outlet port 222 and valve seat 220. The spring 208 can be placed within the first chamber 202, and situated between the membrane 206 (or footing 210, if used) and the pressure adjustment component 212. The pressure adjustment component 212 can be adjusted to achieve a desired downstream water pressure. The water pressure reducer 100 can then be installed in a water line (as shown in FIG. 1, for example).

### Exemplary Method of Implementation

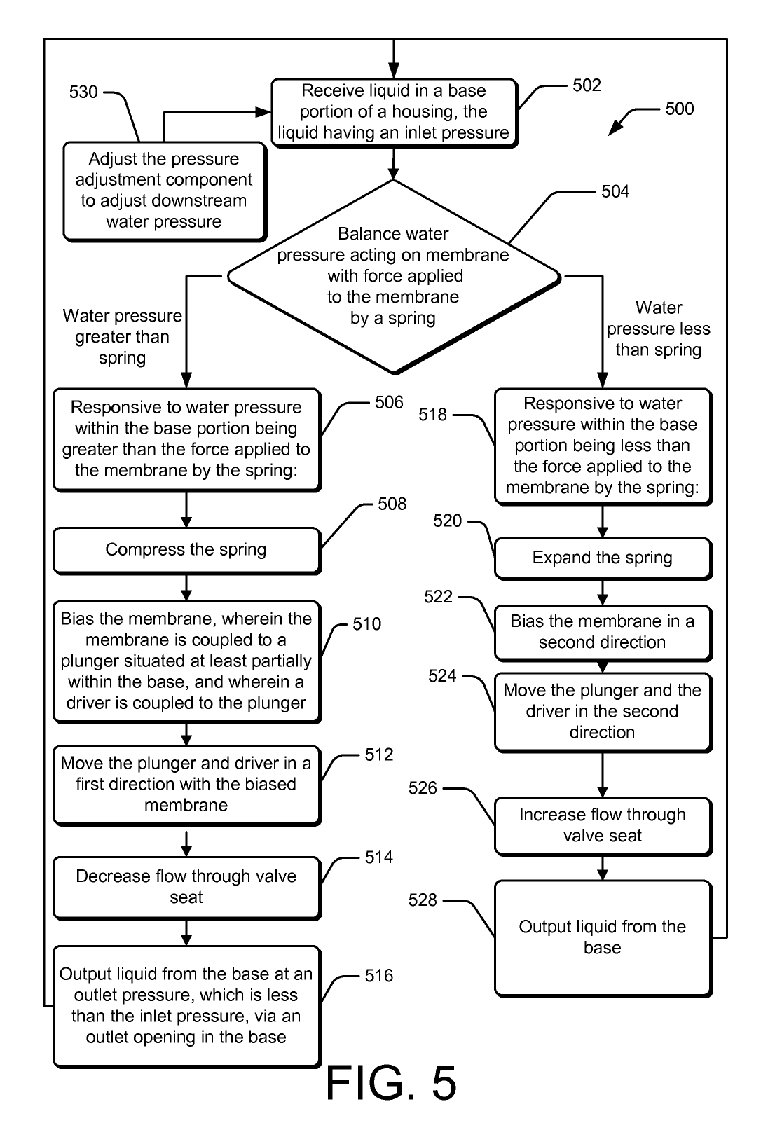

Turning now to FIG. 5, there is illustrated an exemplary method 500 of operating a water pressure reducer 100 such as that disclosed herein.

Before operation, in one embodiment, the water pressure reducer 100 can be installed between the water usage meter 106 and the point where the water line enters the downstream building, as shown in FIG. 1. The water pressure reducer 100 can be installed by threading or clamping the upstream water line 102 into the inlet opening 214 of the second chamber 204 of the base 203, and by threading or clamping the downstream water line 104 into the outlet opening 216 of the second chamber 204 of the base 203. Various sealants, clamps, or components can be used to ensure the upstream and downstream water pipes remain coupled to the water pressure reducer 100.

Before upstream water is allowed to flow into the second chamber 204 of the water pressure reducer 100, the force from the spring 208 can flex or bias the membrane 206 in the direction of the second chamber 204, which can push the plunger 224 away from the first chamber 202 and force the driver 226 away from the valve seat 220. Without water in the second chamber 204, the inlet port 218 can be fully open. The pressure adjustment component 212 may be used to adjust spring tension.

At block 502, the water pressure reducer 100 can receive liquid in the base portion 203 of the housing 200, the liquid having an inlet pressure. In one embodiment, the inlet pressure can be the water pressure within upstream water lines that are connected to the water pressure reducer 100 at the inlet opening 214.

In block 504, liquid from the inlet opening 214 can enter the second chamber 204 defined by the base 203, and fill the second chamber 204. Once the liquid fills the second chamber 204, water pressure can begin to build and exert a force on the membrane 206 counter to the force of the spring 208 within the first chamber 202. Step 504 entails balancing the water pressure within the base 203 acting on the membrane 206 with the force of the spring 208.

In block 506, the membrane 206 responds to water pressure within the base 203 being greater than the force applied to the membrane 206 by the spring 208. Accordingly, the membrane 206 moves toward the spring 208.

In block 508, responsive to the high water pressure against the membrane 206, the spring 208 will compress. The magnitude of compression of the spring 208 depends on the water pressure acting on the membrane 206. By way of example, if the force of the water pressure is only slightly greater than the force of the spring 208, then the spring 208 will compress only slightly, until the force of the spring 208 equals the force of the water against the membrane 206. As the spring 208 compresses, the force of the spring 208 acting on the membrane 206 increases. This is due to the natural increase in force caused by a more coiled spring.

In block 510, the compressed spring 208 can bias the membrane 206, wherein the membrane 206 can be coupled to the plunger 224, which is situated at least partially within the base 203. As described above, the driver 226 can be coupled to the plunger 224.

In block 512, the biased membrane 206 can move the plunger 224 and the driver 226 in a first direction with the biased membrane. In the embodiment shown in FIG. 4, the first direction is toward the cover 201 and away from the base 203 of the housing 200.

At block 514, as the plunger 224 and the driver 226 move in the first direction, the distance between the driver 226 and the valve seat 220 within the base 203 can decrease, such that flow through the valve seat 220 decreases. As shown in FIG. 4, for example, a high upstream water pressure can cause the spring 208 to compress and bias the membrane 206 in the first direction to such an extent that the distance between the driver 226 and the valve seat 220 has decreased such that the driver 226 and the valve seat 220 are engaged. Thus, FIG. 4 shows a fully closed valve seat 220. It should be understood that FIG. 4 represents only one state or configuration of the present disclosure, and the distance between the driver 226 and the valve seat 220 can be any distance between fully engaged (as depicted in FIG. 4), fully open (as depicted in FIG. 3), or any distance between the two (such as, for example, in FIG. 2).

In block 516, liquid from the base 203 can be outputted at an outlet pressure, which is less than the inlet pressure, via the outlet opening 216 in the base 203. As liquid discharges from the base 203, its pressure is low enough to not harm the downstream water lines or appliances connected thereto.

As water within the downstream water lines is used or otherwise removed from the downstream water lines, the water pressure within the downstream water lines can decrease, which can cause a decrease in water pressure within the base 203 of the water pressure reducer 100. When water pressure within the base 203 lessens, step 504 described above can be reevaluated, and the balance between water pressure within the base 203 acting on the membrane 206 and the force applied to the membrane 206 by the spring 208 may shift in favor or the membrane 206 moving to relax the spring.

In block 518, the membrane 206 responds to water pressure within the base 203 being less than the force applied to the membrane 206 by the spring.

In block 520, the spring 208 can expand. The spring 208 relaxes or extends until the force it applies to the membrane 206 equals the force of the water pressure against the membrane. By way of example, if the force of the water pressure is only slightly less than the force of the spring 208, then the spring 208 will expand only slightly. As the spring 208 expands, the force of the spring 208 acting on the membrane 206 decreases. This is due to the natural decrease in force caused by a less coiled spring.

In block 522, the expansion of the spring 208 and reduction in water pressure can allow movement of the membrane 206 in a second direction.

In block 524, the biased membrane 206 can move the plunger 224 and the driver 226 in the second direction with the biased membrane. In the embodiment shown in FIG. 3, the second direction is toward the base 203 and away from the cover 201 of the housing 200.

As the plunger 224 and the driver 226 move in the second direction, the distance between the driver 226 and the valve seat 220 within the base 203 can be increased in step 526, increasing flow through the valve seat 220. As shown in FIG. 3, a low upstream water pressure has caused the spring 208 to expand and bias the membrane 206 in the second direction to such an extent that the distance between the driver 226 and the valve seat 220 has increased from that shown in FIG. 4. The embodiment shown in FIG. 3 represents a fully open inlet port 218. It should be understood that FIG. 3 represents only one embodiment of the present disclosure, and the distance between the driver 226 and the valve seat 220 can be any distance between fully engaged (as depicted in FIG. 4), fully open (as depicted in FIG. 3), or any distance between the two (such as, for example, in FIG. 2).

In block 528, liquid from the base 203 can be outputted via the outlet opening 216 in the base 203. As liquid is outputted from the base 203, it can flow to the downstream water lines with a water pressure low enough to not harm the downstream water lines or appliances connected thereto.

As water pressure within the downstream water lines builds, such as when no appliances in the downstream water line are being used, step 504 described above can again be taken, and a balancing of the water pressure within the base 203 acting on the membrane 206 with the force applied to the membrane 206 by the spring 208 is performed. This process of determining the difference in force between the spring 208 and the water pressure within the base 203 and taking the steps of 506-516 or 518-528 depending on the result of the determination, can be performed continuously and smoothly by the water pressure reducer 100 described herein.

In block 530, the pressure adjustment component 212 can be adjusted at any time, including but not limited to before receiving liquid in the base 203 of the housing 200.

When in use, the water pressure from the upstream water line can be constantly changing. The method of operating water pressure reducers 100 disclosed herein can be repeated or altered continuously such that the distance between the driver 226 and the valve seat 220 can be continuously changing or otherwise be dynamic. Accordingly, a cross-section of a flow passage through the water pressure reducer 100 may be dynamically changed, allowing the reducer to provide greater cross-sectional area when incoming pressure is lower and to provide lesser cross-sectional area when incoming pressure is higher. Also, the membrane 206 can have a flex range wherein the membrane 206 can flex to allow the driver 226 to be a maximum distance from the valve seat 220, creating a fully open position, and wherein the membrane 206 can flex to allow the driver 226 to be engaged with the valve seat 220, creating a fully closed position. The membrane 206 can flex anywhere between and including the fully closed and fully open positions, depending on upstream water pressure.

### CONCLUSION

Although the application describes embodiments having specific structural features and/or methodological acts, it is to be understood that the claims are not necessarily limited to the specific features or acts described. Rather, the specific features and acts are merely illustrative some embodiments that fall within the scope of the claims of the application.

What is claimed is:

1. A water pressure reducer, comprising:
a housing defining an at least partially hollow interior;
a membrane, which divides the interior of the housing into a first chamber and a second chamber and which is movable responsive to changes in water pressure against the membrane;
an inlet opening and an outlet opening defined in the second chamber of the housing;
a valve seat situated within the second chamber;
a plunger situated at least partially within the second chamber, coupled to the membrane, and extending at least partially through the valve seat;
a driver coupled to the plunger and configured to releaseably engage with the valve seat; and
a spring situated within the first chamber, wherein the spring is in compression and biases the plunger such that the driver is not engaged with the valve seat.

2. The water pressure reducer of claim 1, wherein the membrane is responsive to an increase in water pressure within the second chamber resulting in compression of the spring, biasing the plunger in a first direction, wherein distance between the valve seat and the driver decreases.

3. The water pressure reducer of claim 2, wherein the membrane is responsive to a decrease in water pressure within the second chamber resulting in expansion of the spring, biasing the plunger in a second direction, wherein the distance between the valve seat and the driver increases.

4. The water pressure reducer of claim 1, wherein the membrane comprises a flexible material which is movable in a smooth, continuous motion responsive to the changes in water pressure against the membrane.

5. The water pressure reducer of claim 4, wherein the flexible material comprises a polymer which has a tensile strength at least sufficient to withstand a force of compression from the spring and a force of water pressure within the second chamber.

6. The water pressure reducer of claim 1, wherein the plunger extends through the membrane and partially into the first chamber.

7. The water pressure reducer of claim 1, wherein the driver further comprises a gasket configured to make contact with the valve seat.

8. The water pressure reducer of claim 1, wherein the housing is at least partially made of brass.

9. The water pressure reducer of claim 1, wherein the first chamber further comprises a pressure adjustment component coupled to the spring to adjust a force with which the spring biases the plunger.

10. A water pressure reducer, comprising:
a base coupled to a cover;
a membrane situated between the base and the cover and defining a first chamber on one side of the membrane and a second chamber on an opposite side of the membrane, wherein the membrane comprises a flexible material which is movable in a smooth, continuous motion responsive to changes in water pressure against the membrane;
a spring, in compression, and biasing the membrane;
an inlet opening and an outlet opening defined in the second housing;
a valve seat situated between the inlet opening and the outlet opening of the second chamber; and
a plunger situated within the second chamber, coupled to the membrane, and moveable between positions allowing greater or lesser fluid flow.

11. The pressure reducer of claim 10, wherein the membrane is movable responsive to increases in pressure at the inlet opening to bias the plunger and the driver in a first direction to decrease water pressure exiting the outlet opening.

12. The pressure reducer of claim 10, wherein the membrane is movable responsive to decreases in pressure within the second chamber to bias the plunger and the driver in a second direction to increase water pressure exiting the outlet opening.

13. The pressure reducer of claim 10, wherein the first direction is in a direction to bias the driver toward the valve seat, and wherein the second direction is in a direction to bias the driver away from the valve seat.

14. The pressure reducer of claim 10, wherein the flexible material comprises a polymer which has a tensile strength at least sufficient to withstand the force of compression from the spring and the force of water pressure within the second chamber.

15. The pressure reducer of claim 10, wherein the membrane has a flexing range, the flexing range allowing for continuous expansion and compression of the spring.

16. The pressure reducer of claim 10, further comprising a pressure adjustment component situated within the first chamber, wherein the pressure adjustment component is usable to increase and decrease compression of the spring.

17. A method of operating a pressure reducer, the method comprising:
receiving liquid in a base portion of a housing, the liquid having an inlet pressure;
balancing water pressure within the base portion acting on a membrane with a force applied to the membrane by a spring within a cover portion of the housing;
responsive to water pressure within the base portion being greater than the force applied to the membrane by the spring:
compressing the spring;
biasing the membrane, wherein the membrane is coupled to a plunger situated at least partially within the base, and wherein a driver is coupled to the plunger;
moving the plunger and the driver in a first direction;
decreasing flow through the valve seat; and
outputting liquid from the base at an outlet pressure, which is less than the inlet pressure, via an outlet opening in the base.

18. The method of claim 17, further comprising:
responsive to water pressure within the base portion being less than the force applied to the membrane by the spring:
expanding the spring;
biasing the membrane in a second direction;
moving the plunger and the driver in a second direction;
increasing flow through the valve seat; and
outputting liquid from the base.

19. The method of claim 17, additionally comprising adjusting the force of the spring with a pressure adjustment component.

20. The method of claim 17, wherein the membrane and the spring move between positions that allow greater or lesser restriction on fluid flow.
